(19) United States
(12) Patent Application Publication
(10) Pub. No.: US 2021/0150927 A1
(43) Pub. Date: May 20, 2021

(54) REAL-TIME KNOWLEDGE GAP FULLFILMENT

(71) Applicant: International Business Machines Corporation, Armonk, NY (US)

(72) Inventors: Harris Basil Monos, Melbourne (AU); Elaheh ShafieiBavani, Melbourne (AU); Jorge Andres Moros Ortiz, Melbourne (AU); John Wagner, Carlton (AU)

(21) Appl. No.: 16/685,383

(22) Filed: Nov. 15, 2019

(51) Int. Cl. G09B 7/00; G06N 5/04

(52) U.S. Cl. CPC G09B 7/00; G06N 5/04

(57) ABSTRACT

A knowledge graph of a user is generated by extracting concepts included in content consumed and knowledge sources and experience identified by the user. Content delivered to the user is monitored in real-time and extracted concepts are compared to concepts of the user's knowledge graph. A user's knowledge gap is determined for a concept extracted from a portion of the content consumed, based on analysis of a knowledge graph of the user. Responsive to determining whether a knowledge gap for the user exists, the one or more processors determine a user's preference of learning style and delivery media; determine a current location and activity of the user; perform a search of information filling the knowledge gap for the user, and deliver the information filling the knowledge gap for the user in a learning style and media formation consistent with the preference of the user.

### FIELD OF THE INVENTION

The present invention relates generally to the field of augmenting knowledge, and more particularly to providing real-time information filling a knowledge gap of a user.

### BACKGROUND OF THE INVENTION

It is not uncommon for certain terms, phrases or concepts of content material being consumed by a person to be unfamiliar to the person and create uncertainty in fully understanding the consumed material. The consumed material may be delivered in one of a variety of media formats such that the content recipient can view, listen to, or read the content. Unfamiliar terms, acronyms, or phrases can prevent understanding of the presented material, resulting in less than ideal outcomes for both provider and recipient.

Consumers of delivered content have a respective set of knowledge and understanding of topics and terms, based on educational achievements, as well as additional reading and listening activity and social media participation. Consumers of delivered content can find access to tools such as an online dictionary, thesaurus, and other lexical services to facilitate understanding of topics and terms encountered.

### SUMMARY

Embodiments of the present invention disclose a method, computer program product, and system. The embodiments provide a method for real-time filling a knowledge gap of a user, delivered in a contextual manner to the user, based on inferred activity, nearby devices and learning preferences of the user, determined during consumption of content by the user. The method provides for one or more processors to generate a knowledge graph of a user by extracting concepts included in content consumed by the user and by sources of knowledge and acquired experience identified by the user. The one or more processors monitor content delivered to the user in real-time. The one or more processors extract in real-time concepts included in the content. The one or more processors determine a preference of a learning style and delivery media for the user. The one or more processors determine whether a knowledge gap for the user regarding a concept extracted from a portion of the content consumed by the user exists, based on analysis of a knowledge graph of the user. Responsive to confirming the knowledge gap for the user, one or more processors recall the preference of learning style and media delivery for the user. The one or more processors determine a current location and activity of the user. The one or more processors perform a search of information filling the knowledge gap for the user, and the one or more processors deliver the information filling the knowledge gap for the user in a learning style and media formation consistent with the preference of the user.

### BRIEF DESCRIPTION OF THE SEVERAL VIEWS OF THE DRAWINGS

FIG. 1 is a functional block diagram illustrating a distributed data processing environment, in accordance with an embodiment of the present invention.

FIG. 2 is a flowchart illustrating the operational steps of a knowledge gap program operating within the distributed data processing environment of FIG. 1, in accordance with an embodiment of the present invention.

FIG. 3 depicts a block diagram of components of a computing system, including a computing device capable of operationally performing the knowledge gap program of FIG. 2, in accordance with an embodiment of the present invention.

### DETAILED DESCRIPTION

Embodiments of the present invention recognize that people engaged in reading, viewing, or listening to one or more presentations of content, may encounter situations in which the user does not understand certain terms, phrases, expressions, and acronyms used to describe a concept as the content is consumed. In some cases the knowledge gap that occurs may prevent the person from fully understanding the presented content, resulting in incomplete or failure of learning, failure of teaching by the presenter or author, wasted time or requiring additional time to augment the information to fill the knowledge gap and review the content presented again, if still accessible. Often the results include frustration on the part of both presenter and recipient.

Embodiments of the present invention include a method, computer program product, and computer system for providing, in real-time, information to fill a knowledge gap of a user detected while the user consumes content. In some embodiments, the knowledge gap is determined in real-time of the user consuming the content by comparing the content concepts to a knowledge graph generated from concepts and information extracted from content previously consumed by the user, communication and social media content, input by the user regarding educational achievements, up-skill activities and courses taken, work related experience, news, readings, and monitored television. A concept may be or relate to a specific word, terminology, phrase, or subject matter. In some embodiments, the concepts of the consumed content are determined by natural language processing (NLP) and machine learning techniques applied to the received or streaming content consumed by the user.

In some embodiments of the present invention, topics, concepts, and information of content consumed previously by the user are tracked and are extracted and directed to formation of a knowledge graph of the user. In some embodiments, user input to the knowledge graph includes, but is not limited to: educational courses, curriculum, degrees, work experience, resume or CV, badges, on-line up-skilling activity, API input from educational platforms, and social media content. Knowledge graphs of a user are stored and continually updated based on content consumed by the user. Embodiments include receiving input on a user's preference of learning style and delivery, such as in video, audio, text, graphic, or image formats. In some embodiments, users provide a ranked hierarchy of learning style preferences.

In some embodiments, information regarding the location of the user is determined, and the probable activity of the user while consuming content is estimated. The location and activity are considered in selection of delivery of knowledge gap filling information, including the type of alert indicating gap-filling information is available, as well as the choice of delivery of the information, based on the user's immediate environment and available devices to which the information may be delivered.

In some embodiments, to ensure the information provided to fill knowledge gaps is understood and retained by the user, testing for retention of the knowledge gap information is performed after a pre-determined time from delivery of the information, for example, twenty-four to forty-eight hours later. The retention testing determines whether the user has understood and retained the provided information, and results of the testing determine whether the information is added as a concept to the knowledge graph of the user. In some embodiments, the knowledge gap information delivery preferences and order rankings of the user are revalidated as part of or in addition to the retention testing.

In some embodiments in which a plurality of users are simultaneously consuming content (lecture, presentation, video, etc.) the aggregate of individual knowledge graphs of the users is applied to the content consumed and knowledge gaps of the group can be identified during presentation, for example via a haptic, visual, or audio signal to indicate further explanation would be helpful to the audience. In some embodiments, an aggregate knowledge base may help preparation of a presentation to direct time and detail to missing or incomplete content resulting in areas of knowledge gaps.

In some embodiments, delivery of the information to fill knowledge gaps of a user is directed to available devices of the user, minimizing interruption of the consumption of content by the user and minimizing disruption to other users in the near vicinity. In some embodiments, the alert of available information filling a knowledge gap may be an audio signal, a visual signal, a haptic signal, or combinations of signals.

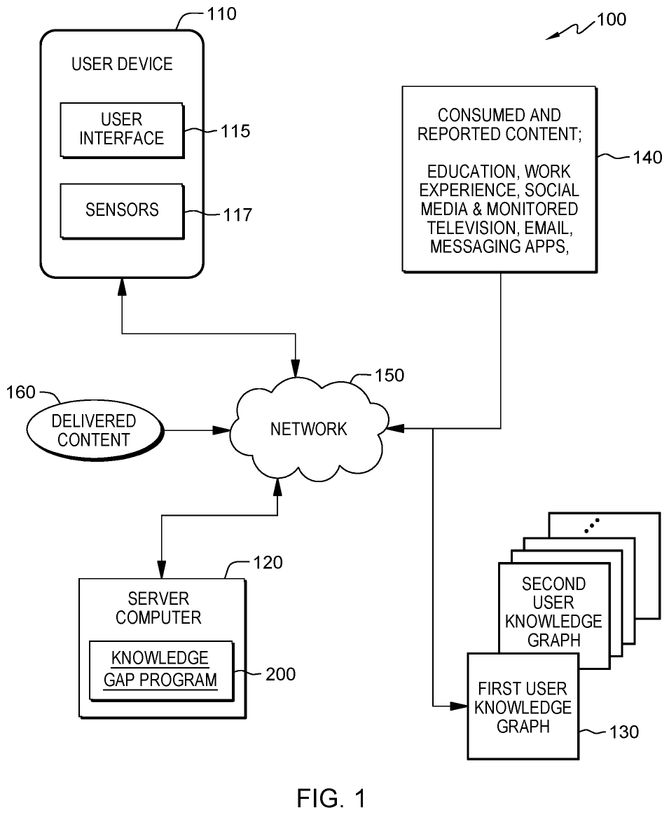

The present invention will now be described in detail with reference to the Figures. FIG. 1 is a functional block diagram illustrating a distributed data processing environment, generally designated 100, in accordance with an embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes user device 110, server computer 120, knowledge graphs 130, consumed and reported content 140, delivered content 160 all connected via network 150.

Network 150 can be, for example, a local area network (LAN), a telecommunications network, a wide area network (WAN), such as the Internet, a virtual local area network (VLAN), or any combination that can include wired, wireless, or optical connections. In general, network 150 can be any combination of connections and protocols that will support communications between user device 110, server computer 120, access to knowledge graphs 130, consumed and reported content 140, and delivered content 160, in accordance with embodiments of the present invention.

User device 110 represents a computing device of a user to receive and consume content or to monitor content consumed by the user. In some embodiments of the present invention, user device 110 includes user interface 115 and sensors 117, providing global positioning system data, accelerometer data, and other data associated with user device 110. In some embodiments of the present invention, user device 110 is one of a plurality of user devices capable of receiving delivered content 160 and information to fill knowledge gaps determined during user consumption of delivered content 160. In some embodiments of the present invention, user device 110 receives and tracks delivered content 160 as it is consumed by the user. In some embodiments, user device 110 interacts with knowledge gap program 200 operating on server computer 120 to extract content concepts and topics in real-time as delivered content 160 is consumed by the user and compare the extracted concepts and topics to the user's knowledge graph of knowledge graphs 130 to determine whether a knowledge gap exists. In some embodiments knowledge gap program 200 resides and operates on user device 110.

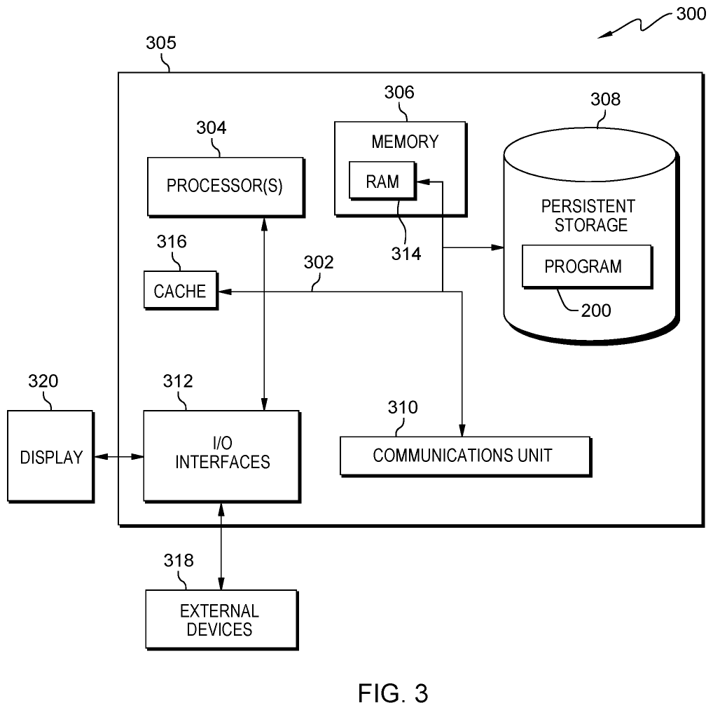

In some embodiments, user device 110 can be a standalone computing device, a smart phone, a tablet computer, a smart watch, a laptop computer, or any other electronic device or computing system capable of receiving, sending, and processing data. In other embodiments, user device 110 can be a computing device interacting with applications and services hosted and operating in a cloud computing environment. In another embodiment, user device 110 can be a netbook computer, a desktop computer, a personal digital assistant (PDA), or other programmable electronic device capable of communicating with server computer 120, a knowledge graph of knowledge graphs 130 corresponding to the user, consumed and reported content 140, delivered content 160, and other computing devices (not shown) within distributed data processing environment 100 via network 150. In another embodiment, user device 110 represents a computing system utilizing clustered computers and components (e.g., database server computers, application server computers, etc.) that act as a single pool of seamless resources when accessed within distributed data processing environment 100. User device 110 includes internal and external hardware components, depicted in FIG. 3.

User interface 115 provides an interface to access features and functions of user device 110. In some embodiments of the present invention, knowledge gap program 200 resides and operates on a device of user device 110, and user interface 115 provides access to knowledge gap program 200. User interface 115 also supports access to other applications, features, and functions of a device of user device 110. User interface 115 supports access to alerts, notifications, and other forms of communications. In one embodiment, user interface 115 may be a graphical user interface (GUI) or a web user interface (WUI) and can receive user input and display text, documents, web browser windows, user options, application interfaces, and instructions for operation, and include the information (such as graphic, text, and sound) that a program presents to a user and the control sequences the user employs to control the program. In another embodiment, user interface 115 may also be mobile application software that provides an interface to features and functions of a device of user device 110. User interface 115 enables a user of user device 110 to receive, view, hear, and respond to input, access applications, and perform functions available.

Sensors 117 provide global positioning system data, accelerometer data, and other data associated with the particular device of user device 110. The collection of data from sensors 117 includes consent by the user opting-in on the collection and use of data. Embodiments of the present invention maintain deactivation of sensors 117 without explicit user consent. In some embodiments sensors 117 indicate the location and activity associated with the user of user device 110, for example, a moving location and accelerometer data may indicate the user of user device 110 is walking, jogging, or driving/riding in a vehicle. In other embodiments, data of sensors 117 indicates a user is sedentary at a location associated with work or education.

Server computer 120 is a server computer knowledge gap program 200. Server computer 120 can be a standalone computing device, a smart phone, a tablet computer, a laptop computer, or any other electronic device or computing system capable of receiving, sending, and processing data. In other embodiments, server computer 120 can represent a computing device interacting with applications and services hosted and operating in a cloud computing environment. In another embodiment, server computer 120 can be a netbook computer, a desktop computer, a personal digital assistant (PDA), or other programmable electronic device capable of communicating with user device 110, knowledge graphs 130, consumed and reported content 140, delivered content 160, and other computing devices (not shown) within distributed data processing environment 100 via network 150. In another embodiment, server computer 120 represents a computing system utilizing clustered computers and components (e.g., database server computers, application server computers, etc.) that act as a single pool of seamless resources when accessed within distributed data processing environment 100. Server computer 120 may include internal and external hardware components, depicted in FIG. 3.

Knowledge gap program 200 provides real-time information to fill a knowledge gap of a user detected while the user consumes content. Knowledge gap program 200 determines the knowledge gap in real-time by comparing the concepts of delivered content 160 to a knowledge graph generated from concepts and information extracted from previously consumed content or knowledge reported by the user. In response to determining a knowledge gap, knowledge gap program 200 performs a search for the information to fill the knowledge gap, for example, by using a web browser and performing a search query of the concept or topic of the knowledge gap. Knowledge gap program 200 alerts the user that information is available by providing a signal on a smart device of the user. The signal may be an audio signal, a visual signal, a haptic signal, or any combination of signals, or other signal. The user acknowledges the signal and receives the information to fill the knowledge gap, consistent with the location, activity, and preference of the user.

A concept may be, or relate to, a specific word, terminology, phrase, or subject matter. The knowledge graph of the user includes concepts and topics previously consumed by the user and input by the user. In some embodiments, user input to the knowledge graph includes, but is not limited to: educational courses, curriculum, degrees, work experience, resume or CV, badges, on-line up-skilling activity, news, readings, monitored television, API input from educational platforms, and the user's consented communication and social media sources. In some embodiments, the concepts of the consumed content are determined by natural language processing (NLP) and machine learning techniques applied to the received or streaming content consumed by the user. Knowledge graphs of a user are stored and continually updated based on content consumed by the user.

Knowledge gap program 200 includes input of user preference of learning style and format, which are considered in delivery of information to fill the determined knowledge gap of a user consuming content, such as delivered content 160. Learning style and format may include, but are not limited to, video, audio, text, graphic, or image formats. In some embodiments, the location of the user and the estimated activity of the user are determined and considered in providing an appropriate delivery of information filling the determined knowledge gap. For example, a user attending a presentation in a facility that includes many other users receives delivery of information to fill a knowledge gap detected in the presentation by initiating a haptic alert on the user's smart phone and providing a text message explaining the concept that generated the knowledge gap.

In some embodiments of the present invention, knowledge gap program 200 includes techniques to validate effectiveness of the information provided to fill knowledge gaps. Users may indicate feedback confirming the adequacy of information provided to fill knowledge gaps and may request greater detail or more summarized levels of information. Knowledge gap program 200 includes features to test the retention of user regarding information provided to fill knowledge gaps. In some embodiments, testing is done at a pre-determined time subsequent to the delivery of the provided knowledge gap filling information and may include multiple questions or queries testing the retention level in different ways. Knowledge gap program 200 confirms whether the user retains understanding of the provided information based on the user's responses to the testing and, if confirmed, adds the concepts of the information provided to the user's knowledge graph. In some embodiments of the present invention, testing questions may also include queries to reverify the user's preference and ranked hierarchy of delivery format.

Knowledge graphs 130 include a plurality of knowledge graphs for respective users of knowledge gap program 200. In some embodiments, knowledge graphs 130 are generated from extraction of concepts from previously consumed content tracked by smart devices, such as user device 110. Concepts may include, but are not limited to: terms, words, phrases, terminology, expressions, and acronyms. Knowledge graphs 130 are used to compare, in real-time, extracted concepts from content consumed by a user. Knowledge gap program 200 compares the extracted concepts to the knowledge graph and determines whether a gap exists between the extracted concepts and the knowledge graph. Knowledge graphs 130 searches for information to fill determined knowledge gaps, and provides the information to the user, consistent with the location, activity, and preference of the user.

Consumed and reported content 140 includes extracted concepts from content previously consumed by the user. In some embodiments of the present invention, consumed and reported content 140 includes: content consumed from readings, news, on-line course, user-reported educational courses, curriculums, degrees, work experience, resume or CV, badges, on-line up-skilling activity, monitored television, API input from educational platforms, and the user's consented communication and social media sources. In some embodiments, the concepts of the consumed content are determined by natural language processing (NLP) and machine learning techniques applied to the previously consumed content. In some embodiments the concepts extracted from consumed and reported content 140 occur during tracking of the delivery of the content as consumed by the user.

Delivered content 160 represents an instance of content delivered to a user and received and/or tracked by user device 110 communicatively connected to knowledge gap program 200 operating on sever computer 120. In some embodiments of the present invention, knowledge gap program resides and operations on user device 110 and receives input of delivered content 160 as a user of user device 110 consumes the content.

In some embodiments, the consumed content may be, but are not limited to a format of digitized text, video, audio, live or recorded presentations, and lectures. In some embodiments, audio content is transformed by speech recognition technology and concepts are extracted using NLP and machine learning techniques. Concepts of video and image content may be extracted by object recognition and/or from metadata associated with the video and image.

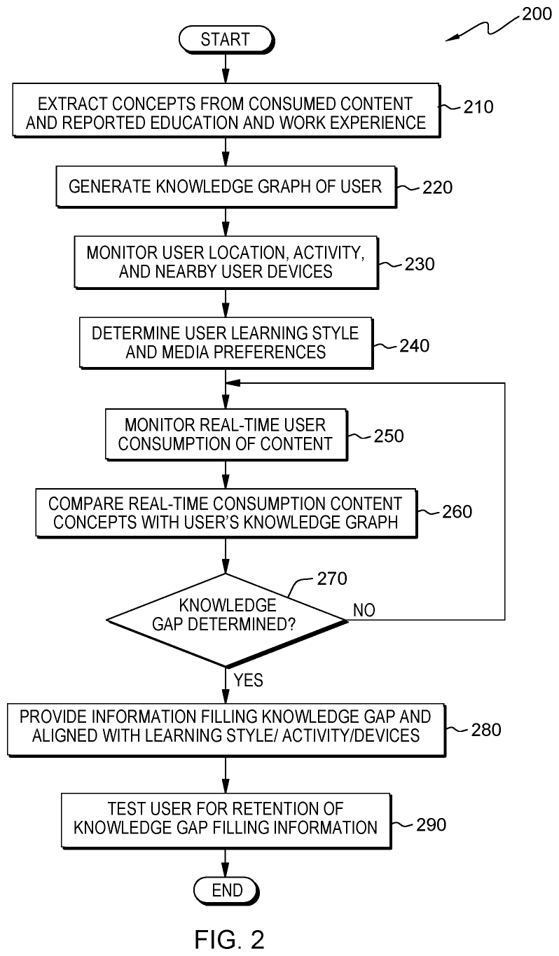

FIG. 2 is a flowchart illustrating the operational steps of knowledge gap program 200 operating within the distributed data processing environment of FIG. 1, in accordance with an embodiment of the present invention.

Knowledge gap program 200 extracts concepts from consumed content and reported education, and work experience (step 210). In some embodiments of the present invention, knowledge gap program 200 uses NLP techniques and machine learning to extract concepts and topics from content previously consumed by a user. In some embodiments, knowledge gap program 200 resides and operates on user device 110 which is used to receive or monitor content consumed by the user. Concepts and topics of the content, which may include, but are not limited to: words, terms, phrases, expressions, sentences, and acronyms, are extracted as the content is delivered to and consumed by the user. In some embodiments, knowledge gap program 200 extracts concepts from user input reporting acquired knowledge concepts based on courses and educational curriculums taken, or work experience, and stored in consumed and reported content 140.

Knowledge gap program 200 generates a knowledge graph of the user (step 220). Having extracted concepts from consumed content, knowledge gap program 200 applies machine learning and deep learning techniques to generate a knowledge graph for the user in which the knowledge graph represents the interconnection and relation of concepts and topics understood by the user. The knowledge graph of the user is continually updated based on content consumed by the user.

In some embodiments, knowledge gap program 200 accesses knowledge graphs of multiple users that are aggregated to obtain a collective knowledge graph of a group or community. In some embodiments of the present invention, an aggregated knowledge graph is used to determine a collective knowledge gap of an audience, or to better prepare presentation content prior to delivery to an audience.

Knowledge gap program 200 monitors user location, activity, and nearby user devices (step 230). In some embodiments of the present invention, knowledge gap program 200 receives data from sensors of a mobile device of the user, for example, sensors 117 of user device 110. The sensors provide location information (GPS), and movement data, which can provide an estimate of activity, based on gyroscope and accelerometer data combined with location. In some embodiments, a stationary location of the user for extended time, with no or low accelerometer data may indicate an activity of sitting or standing, whereas changing of location at speeds above those associated with walking or running may indicate an activity of driving or riding a vehicle. In some embodiments, a frequently attended location may be associated with a workplace, school, home, or other frequented location to which activity may be assigned.

By monitoring the location and estimating activity of the user, knowledge gap program 200 can determine the most appropriate delivery mode and media of information filling a determined knowledge gap of the user. For example, if the user is listening to a podcast while walking, knowledge gap program 200 may provide an audio alert signal and provide the gap-filling information by muting or pausing the podcast and providing an audio message of the information. Alternatively, knowledge gap program 200 may provide an alert and deliver a text message including the gap-filling information avoiding interruption of the podcast. In situations in which the user is attending presentation of content among an audience of attendees, the gap-filling alert by knowledge gap program 200 may be a haptic signal and a text message that includes the information to avoid disruption of the on-going presentation.

Knowledge gap program 200 determines user learning style and media preferences (step 240). Embodiments of the present invention recognize that some users may prefer receiving information organized into charts and graphs, whereas others may prefer written explanations, or images and drawings. In some embodiments of the present invention, knowledge gap program 200 determines a user's preferred learning style and media type by requesting the user to provide a hierarchical ranking of preferences. Additionally, embodiments of the present invention monitor the chosen media inputs of content consumption by the user to continually update the user's preference of learning modes when presenting information to fill knowledge gaps.

For example, knowledge gap program 200 requests a user's input ranking preferred learning formats to which the user inputs in preferred order: written explanation, audio message, charts and graphs, and images. Knowledge gap program 200 continues monitoring of content consumed by the user noting that three content pieces were on-line written articles and one was an online audio podcast, further validating the user's indicated preferences.

Knowledge gap program 200 tracks real-time user consumption of content (step 250). Knowledge gap program 200 tracks the content consumed by the user on one of the user's devices, such as user device 110. The content is extracted and processed using NLP and machine learning techniques to identify concepts and topics of the consumed content in real-time. In some embodiments, the content is displayed or audibly delivered via a device of the user. In other embodiments, such as viewing content on a television, a device of the user located nearby the user while viewing content on the television monitors the audible (and in some cases visual) content. Knowledge gap program 200 receives the content from the monitoring device and processes the content to extract concepts and topics.

For example, suppose a user is listening to a podcast on their smart phone while walking. Knowledge gap program 200 tracks the audible content, converts the audible content to digitized text, and submits the digitized text to natural language processing and machine learning function to extract the concepts and topics included in the content. In some embodiments the processing of the content to extract the concepts is performed by a module component of knowledge gap program 200. In other embodiments, knowledge gap program 200 transmits digitized content to a natural language processing service via an API and receives the concepts and topics of the content.

Knowledge gap program 200 compares real-time consumption of content concepts with the user's knowledge graph (step 260). Knowledge gap program 200 compares the extracted consumption content concepts and topics in real-time to the concepts and topics included in the knowledge graph of the user. In some embodiments, comparison of the extracted concepts from the content consumed by the user to the knowledge graph of the user identifies whether the content concept is one understood by and familiar to the user. In some embodiments the knowledge graph may include concepts similar by not exactly matching the concept of the consumed content, in which case knowledge gap program 200 may apply a threshold of a quantity of connected similar concepts to determine whether the concept is likely understood by the user. In such cases, if the threshold quantity is met, knowledge gap program 200 determines that the concept is understood by the user.

Knowledge gap program 200 determines whether a knowledge gap is determined (decision step 270). The extracted concepts of the consumed content are compared to the user's knowledge graph to determine whether the concepts are found in the user's knowledge graph, indicating familiarity and understanding by the user, or in some embodiments, a quantity of similar concepts that indicate strong interconnection, exceeding a predetermined threshold. If the extracted concept, or interconnected similar concepts exceeding a threshold are not found in the user's knowledge graph, knowledge gap program 200 determines a knowledge gap exists.

For the case in which knowledge gap program 200 does not determine a knowledge gap (step 270, “NO” branch), knowledge gap program 200 returns to step 250 and continues to monitor real-time user consumption of content and proceeds as described previously. For the case in which knowledge gap program 200 determines a knowledge gap during consumption of content by the user (step 270, “YES” branch), knowledge gap program 200 provides information filling the knowledge gap and aligned with learning style and activity preferences of the user (step 280).

Knowledge gap program 200 performs an online search in real-time for information explaining or describing the concept extracted from the consumed content that triggered determination of a knowledge gap of the user and provides the information to the user to fill the knowledge gap determined during the real-time consumption of content by the user. In some embodiments, knowledge gap program 200 locates and retrieves brief information to fill the knowledge gap and more detailed explanation associated with the concept of the knowledge gap. Knowledge gap program 200 may provide the brief information initially to the user to fill the knowledge gap and may query the user if additional information (in greater detail) is requested, to which knowledge gap program 200 responds with the more detailed explanation associated with the concept of the knowledge gap. In some embodiments, knowledge gap program 200 determines the location and estimated activity of the user and provides the information to fill the knowledge gap consistent with preference of learning style and appropriate for the activity of the user.

In some embodiments, the activity of the user is determined by sensor data indicating the location of the user, by GPS data, and accelerometer and gyroscope data indicating movement of the user. In some embodiments, certain locations and sensor data are associated with common repetitive activity of the user, such as attending educational classes on a regular basis (at a school or university), attending meetings at a place of work, public meetings at municipal locations, or watching a documentary presentation at the user's home location. Knowledge gap program 200 determines, based on the estimated activity and location of the user, the preferred and appropriate notification of information available to fill a knowledge gap, and delivery of the information to nearby device of the user in a media format that is consistent with the current environment and conditions associated with the user.

For example, suppose the user is attending a public meeting discussing the analysis and condition of the local water supply. The user is among dozens of people in attendance and is monitoring the audible delivery of the meeting's content with their smart phone, communicatively connected to knowledge gap program 200. An analysis term is used by the presenter and knowledge gap program 200 determines from comparing the term to the user's knowledge graph that the term is a knowledge gap for the user. Knowledge gap program 200 searches for information to explain the meaning and usage of the term and alerts the user with a haptic signal on their smart phone. Following confirmation of the alert by the user, knowledge gap program 200 provides the information to fill the knowledge gap by presenting a silent text message that does not disrupt the presentation.

Knowledge gap program 200 performs a test of the user for retention of the knowledge gap filling information provided (step 290). Having provided the knowledge gap filling information, knowledge gap program 200, at a pre-determined time subsequent to providing the information, presents the user with one or more queries that test the user's retention of the information provided to fill the previous knowledge gap while the user was consuming the presented content. In some embodiments, the queries include questions testing the retention of the information provided from different aspects and different formats. Knowledge gap program 200 determines from the responses to the queries whether the user has adequate retention of the information and, confirming retention, adds the concept associated with the provided information to fill the previous knowledge gap to the user's knowledge graph.

Having completed the user's retention test and updating the user's knowledge graph as appropriate, knowledge gap program 200 ends. The following use cases are included to further clarify aspects of embodiments of the present invention:

A user is walking in the park and listening to a podcast about cancer when the presenter mentions Tamoxifen. Immediately recognizing that the user's knowledge graph does not include the concept of Tamoxifen or related concept chemotherapy, the system will choose to use audio to deliver a simple explanation of both chemotherapy and Tamoxifen so that the user does not have to pause their walk or pull the device out of their pocket.

A user is attending a seminar with multiple attendees and is listening to a presenter discuss the local housing market. When the presenter mentions negative gearing, the system recognizes that the user knows very little about investment, and delivers a short, silent (subtitled) video via the user's mobile phone so that the user does not disturb others attending the lecture.

A user is at home sitting on the couch listening to an information talk program on their living room speakers. The system chooses a combination of turning on the television to show a simple graph, and the user uses their watch to navigate the graph (kinesthetic feedback). In this way, the user's visual and kinesthetic learning preference is used through the devices available nearby.

FIG. 3 depicts a block diagram of components of computing system 300, including computing device 305, configured to include or operationally connect to components depicted in FIG. 1, and capable of performing operational steps of knowledge gap program 200 of FIG. 3, in accordance with an embodiment of the present invention.

Computing device 305 includes components and functional capability similar to user device 110 and server computer 120 (FIG. 1), in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

Computing device 305 includes communications fabric 302, which provides communications between computer processor(s) 304, memory 306, persistent storage 308, communications unit 310, and input/output (I/O) interfaces 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306, cache memory 316, and persistent storage 308 are computer readable storage media. In this embodiment, memory 306 includes random access memory (RAM) 314. In general, memory 306 can include any suitable volatile or non-volatile computer readable storage media.

In one embodiment, knowledge gap program 200 is stored in persistent storage 308 for execution by one or more of the respective computer processors 304 via one or more memories of memory 306. In this embodiment, persistent storage 308 includes a magnetic hard disk drive. Alternatively, or in addition to a magnetic hard disk drive, persistent storage 308 can include a solid-state hard drive, a semiconductor storage device, read-only memory (ROM), erasable programmable read-only memory (EPROM), flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices, including resources of distributed data processing environment 100. In these examples, communications unit 310 includes one or more network interface cards. Communications unit 310 may provide communications through the use of either or both physical and wireless communications links. Knowledge gap program 200 may be downloaded to persistent storage 308 through communications unit 310.

I/O interfaces 312 allows for input and output of data with other devices that may be connected to computing system 300. For example, I/O interfaces 312 may provide a connection to external devices 318 such as a keyboard, keypad, a touch screen, and/or some other suitable input device. External devices 318 can also include portable computer readable storage media such as, for example, thumb drives, portable optical or magnetic disks, and memory cards. Software and data used to practice embodiments of the present invention, e.g., knowledge gap program 200, can be stored on such portable computer readable storage media and can be loaded onto persistent storage 308 via I/O interfaces 312. I/O interfaces 312 also connect to a display 320.

Display 320 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for real-time filling of a knowledge gap of a user determined during consumption of content by the user, the method comprising:
one or more processors generating a knowledge graph of a user by extracting concepts included in content consumed by the user and by sources of knowledge and acquired experience identified by the user;
the one or more processors monitoring content delivered to the user in real-time;
the one or more processors extracting, in real-time, concepts included in the content;
the one or more processors determining a preference of a learning style and a delivery media for the user;
the one or more processors determining whether a knowledge gap regarding a concept extracted from a portion of the content consumed by the user exists, based on analysis of the knowledge graph of the user;
responsive to confirming the knowledge gap exists, the one or more processors:
recalling the preference of learning style and media delivery for the user;
determining a current location and activity of the user;
performing a search of information filling the knowledge gap for the user; and
delivering the information filling the knowledge gap for the user in a learning style and media formation consistent with the preference of learning style and media delivery of the user.

2. The method of claim 1, further comprising:
the one or more processors testing the user for retention of the information filling the knowledge gap, provided to the user; and
the one or more processors, responsive to determining the user has retained understanding of the information filling the knowledge gap, adding the concept associated with the knowledge gap to the knowledge graph of the user.

3. The method of claim 2, wherein testing the user for retention of the information filling the knowledge gap is performed at a pre-determined time at least 24 hours subsequent to delivery of the information.

4. The method of claim 1, further comprising:
the one or more processors alerting the user that the information to fill the knowledge gap is available on a device available to the user by presenting one or a combination of signal types selected from a group consisting of: an audio signal, a visual signal, and a haptic signal.

5. The method of claim 1, further comprises:
the one or more processors determining the knowledge gap by comparing concepts extracted from the content consumed by the user to the knowledge graph of the user; and
the one or more processors delivering the information filling the knowledge gap of the user in real time, based on inferred activity of the user, devices nearby the user, and learning preferences of the user, wherein the information is delivered in a media type, format, and to a device that minimizes interruption of the content consumed by the user.

6. The method of claim 1, further comprising:
the one or more processors detecting one or more user devices nearby the user and a first device of the one or more user devices on which the user is receiving the content consumed; and
the one or more processors delivering the information filling the knowledge gap to a device of the of the one or more user devices nearby the user, other than the first device and avoiding disruption of the consumption of the content by the user.

7. The method of claim 1, wherein the knowledge graph is an agglomerated graph of a group of users simultaneously consuming the content delivered to the users in real-time, and wherein an alert is generated and delivered to a provider of the content indicating a collective knowledge gap among a plurality of the group of users.

8. The method of claim 1, wherein the content is prepared based on determining knowledge gaps of a plurality of users by comparing concepts of the content to an agglomerated knowledge graph of the plurality of users.

9. The method of claim 1, wherein the location and activity of the user is determined based on global positioning service (GPS), accelerometer, and gyroscope data of a smart device of the user.

10. A computer program product method for real-time filling of a knowledge gap of a user determined during consumption of content by the user, the computer program product comprising:
one or more computer readable storage media and program instructions stored on the one or more computer readable storage media, the program instructions comprising:
program instructions to generate a knowledge graph of a user by extracting concepts included in content consumed by the user and by sources of knowledge and acquired experience identified by the user;
program instructions to monitor content delivered to the user in real-time;
program instructions to extract, in real-time, concepts included in the content;
program instructions to determine a preference of a learning style and delivery media for the user;
program instructions to determine whether a knowledge gap regarding a concept extracted from a portion of the content consumed by the user exists, based on analysis of the knowledge graph of the user;
responsive to confirming the knowledge gap exists, program instructions to:
recall the preference of learning style and media delivery for the user;
determine a current location and activity of the user;
perform a search of information filling the knowledge gap for the user; and
deliver the information filling the knowledge gap for the user in a learning style and media formation consistent with the preference of learning style and media delivery of the user.

11. The computer program product of claim 10, further comprising:
program instructions to test the user for retention of the information filling the knowledge gap, provided to the user, wherein testing is performed at a pre-determined time at least 24 hours subsequent to delivery of the information; and
responsive to determining the user has retained understanding of the information filling the knowledge gap, program instructions to add the concept associated with the knowledge gap to the knowledge graph of the user.

12. The computer program product of claim 10, further comprising responsive to confirming the knowledge gap for the user, program instructions to determine the location and activity of the user based on global positioning service (GPS), accelerometer, and gyroscope data of a smart device of the user; and
program instructions to alert the user that the information to fill the knowledge gap is available on a device available to the user by presenting one or a combination of signal types selected from a group consisting of: an audio signal, a visual signal, and a haptic signal.

13. The computer program product of claim 10, further comprising:
program instructions to determine the knowledge gap by comparing concepts extracted from the content consumed by the user to the knowledge graph of the user; and
program instructions to deliver the information filling the knowledge gap of the user in real time, based on inferred activity of the user, devices nearby the user, and learning preferences of the user, wherein the information filling the knowledge gap of the user in real time, based on inferred activity of the user, devices nearby the user, and learning preferences of the user, wherein the information is delivered in a media type, format, and to a device that minimizes interruption of the content consumed by the user.

14. The computer program product of claim 10, wherein the knowledge graph is an agglomerated graph of a group of users simultaneously consuming the content delivered to the users in real-time, and wherein an alert is generated and delivered to a provider of the content indicating a collective knowledge gap among a plurality of the group of users.

15. A computer system for real-time filling of a knowledge gap of a user determined during consumption of content by the user, the computer system comprising:
one or more computer processors;
one or more computer readable storage media; and
program instructions stored on the one or more computer readable storage media, the program instructions comprising:
program instructions to generate a knowledge graph of a user by extracting concepts included in content consumed by the user and by sources of knowledge and acquired experience identified by the user;
program instructions to monitor content delivered to the user in real-time;
program instructions to extract, in real-time, concepts included in the content;
program instructions to determine a preference of a learning style and delivery media for the user;
program instructions to determine whether a knowledge gap regarding a concept extracted from a portion of the content consumed by the user exists, based on analysis of the knowledge graph of the user;
responsive to confirming the knowledge gap exists, program instructions to:
recall the preference of learning style and media delivery for the user;
determine a current location and activity of the user;
perform a search of information filling the knowledge gap for the user; and
deliver the information filling the knowledge gap for the user in a learning style and media formation consistent with the preference of learning style and media delivery of the user.

16. The computer system of claim 15, further comprising:
program instructions to detect one or more user devices nearby the user and a first device of the one or more user devices on which the user is receiving the content consumed; and
the one or more processors delivering the information filling the knowledge gap to a device of the of the one or more user devices nearby the user, other than the first device and avoiding disruption of the consumption of the content by the user.

17. The computer system of claim 15, wherein the content is prepared based on determining knowledge gaps of a plurality of users by comparing concepts of the content to an agglomerated knowledge graph of the plurality of users.

18. The computer system of claim 15, further comprising:
program instructions to test the user for retention of the information filling the knowledge gap, provided to the user, wherein testing is performed at a pre-determined time at least 24 hours subsequent to delivery of the information; and
responsive to determining the user has retained understanding of the information filling the knowledge gap, program instructions to add the concept associated with the knowledge gap to the knowledge graph of the user.

19. The computer system of claim 15, further comprising
responsive to confirming the knowledge gap for the user, program instructions to determine the location and activity of the user based on global positioning service (GPS), accelerometer, and gyroscope data of a smart device of the user; and
program instructions to alert the user that the information to fill the knowledge gap is available on a device available to the user by presenting one or a combination of signal types selected from a group consisting of: an audio signal, a visual signal, and a haptic signal.

20. The computer system of claim 15, further comprising:
program instructions to determine the knowledge gap by comparing concepts extracted from the content consumed by the user to the knowledge graph of the user; and
program instructions to deliver the information filling the knowledge gap of the user in real time, based on inferred activity of the user, devices nearby the user, and learning preferences of the user, wherein the information filling the knowledge gap of the user in real time, based on inferred activity of the user, devices nearby the user, and learning preferences of the user, wherein the information is delivered in a media type, format, and to a device that minimizes interruption of the content consumed by the user.
